(19) United States
(12) Patent Application Publication
(10) Pub. No.: US 2025/0239064 A1
(43) Pub. Date: Jul. 24, 2025

(54) INFORMATION PROCESSING APPARATUS, SYSTEM, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Kimihiro MASUYAMA, Tokyo (JP)

(21) Appl. No.: 19/011,688

(22) Filed: Jan. 7, 2025

(30) Foreign Application Priority Data
Jan. 18, 2024 (JP) 2024-006207

(51) Int. Cl. G06V 10/82; G06N 3/09

(52) U.S. Cl. CPC G06V 10/82; G06N 3/09

(57) ABSTRACT

An information processing apparatus comprises an obtaining unit configured to obtain a data set shared by users, and an instructing unit configured to issue an instruction for supervised learning based on the data set obtained by the obtaining unit. Attribute information of the data set includes a number of pieces of data included in the data set and an evaluation index value representing a user evaluation for the data set.

### BACKGROUND OF THE INVENTION

### Field of the Invention

The present invention relates to a learning technology.

### Description of the Related Art

In recent years, the use of artificial intelligence (AI) in various fields has been advancing. One example is supervised learning in which machine learning is performed on the basis of teacher data including correct data to generate an inference model.

In the supervised learning, various inputs determined by the task to solve and teacher data including annotation data provided with high quality ground truth (GT) for the input are needed to obtain a machine learning model with high generalization performance. Typically, high quality teacher data uses an open data set created for a purpose such as a competition or the like, and if there is no teacher data tailored to the purpose, a data set has to be created by yourself. In this manner, creating teacher data for supervised learning requires both technical knowledge and time.

Japanese Patent No. 6682011 describes a method for presenting teacher data that works well with a sensor device used by a buyer of teacher data at a place where teacher data used in machine learning can be bought and sold.

However, teacher data that works well with the sensor device is not guaranteed to have high annotation quality.

### SUMMARY OF THE INVENTION

The present invention provides technology for realizing high quality supervised learning.

According to the first aspect of the present disclosure, there is provided an information processing apparatus comprising: an obtaining unit configured to obtain a data set shared by users; and an instructing unit configured to issue an instruction for supervised learning based on the data set obtained by the obtaining unit, wherein attribute information of the data set includes a number of pieces of data included in the data set and an evaluation index value representing a user evaluation for the data set.

According to the second aspect of the present disclosure, there is provided a system comprising: an information processing apparatus including an obtaining unit configured to obtain a data set shared by users, and an instructing unit configured to issue an instruction for supervised learning based on the data set obtained by the obtaining unit, wherein attribute information of the data set includes a number of pieces of data included in the data set and an evaluation index value representing a user evaluation for the data set; and a server apparatus, wherein the server apparatus includes a first processing unit configured to obtain a read rate of a data set on a basis of a number of pieces of data included in the data set used in a project and a weighting input according to a user operation in the information processing apparatus for the data set, a second processing unit configured to obtain an evaluation index value representing a user evaluation of a data set on a basis of a sum of read rates obtained for each project for the data set, and a third processing unit configured to perform supervised learning on a basis of an instruction from the instructing unit and the evaluation index value.

According to the third aspect of the present disclosure, there is provided a system comprising: an information processing apparatus including an obtaining unit configured to obtain a data set shared by users, and an instructing unit configured to issue an instruction for supervised learning based on the data set obtained by the obtaining unit, wherein attribute information of the data set includes a number of pieces of data included in the data set and an evaluation index value representing a user evaluation for the data set; and a server apparatus, wherein the server apparatus includes a first processing unit configured to obtain an evaluation index value representing a user evaluation of a data set on a basis of an attribute associated with identification information of a user associated with the data set, and a second processing unit configured to perform supervised learning on a basis of an instruction from the instructing unit and the evaluation index value.

According to the fourth aspect of the present disclosure, there is provided an information processing method executed by an information processing apparatus, comprising: obtaining a data set shared by users; and issuing an instruction for supervised learning based on the obtained data set, wherein attribute information of the data set includes a number of pieces of data included in the data set and an evaluation index value representing a user evaluation for the data set.

According to the fifth aspect of the present disclosure, there is provided a non-transitory computer-readable storage medium configured to cause a computer to function as: an obtaining unit configured to obtain a data set shared by users; and an instructing unit configured to issue an instruction for supervised learning based on the data set obtained by the obtaining unit, wherein attribute information of the data set includes a number of pieces of data included in the data set and an evaluation index value representing a user evaluation for the data set.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a system.

FIG. 2 is a block diagram illustrating an example of the hardware configuration of a computer apparatus.

FIG. 3 is a block diagram illustrating an example of the functional configurations of a web server 103, a storage server 104, a learning server 105, and a client terminal 102.

FIG. 4 is a flowchart of the processing executed in supervised learning to train and test an inference model.

FIG. 5A is a diagram illustrating an example display of a web screen.

FIG. 5B is a diagram illustrating an example display of the web screen.

FIG. 5C is a diagram illustrating an example display of the web screen.

FIG. 5D is a diagram illustrating an example display of the web screen.

FIG. 6A is a diagram illustrating a table configuration example.

FIG. 6B is a diagram illustrating a table configuration example.

FIG. 6C is a diagram illustrating a table configuration example.

FIG. 7 is a flowchart of the processing executed in supervised learning to train and test an inference model.

FIG. 8A is a diagram illustrating an example display of the web screen.

FIG. 8B is a diagram illustrating an example display of the web screen.

FIG. 8C is a diagram illustrating an example display of the web screen.

FIG. 8D is a diagram illustrating an example display of the web screen.

FIG. 9 is a diagram illustrating a table configuration example.

FIG. 10A is a diagram illustrating a table configuration example.

FIG. 10B is a diagram illustrating a table configuration example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

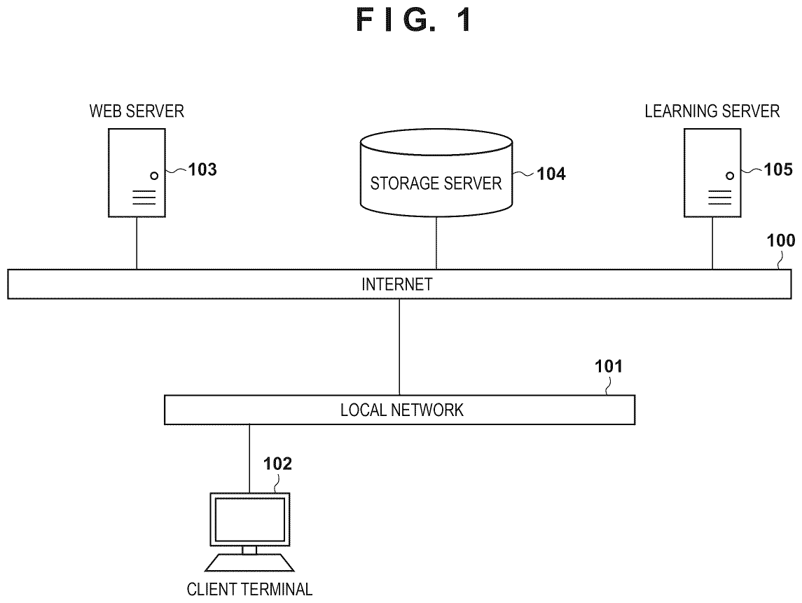

First, an example configuration of a system according to the present embodiment will be described using FIG. 1. As illustrated in FIG. 1, the system according to the present embodiment includes a web server 103, a storage server 104, a learning server 105, and a client terminal 102.

The web server 103, the storage server 104, and the learning server 105 are connected to an Internet 100, and the client terminal 102 is connected to a local network 101. Also, the local network 101 is connected to the Internet 100 via a non-illustrated device.

The client terminal 102 is a terminal operated by the user for supervised learning. In FIG. 1, one client terminal 102 is illustrated to simply description, but in practice, a plurality of client terminals 102 are connected to the local network 101 and the Internet 100. As the client terminal 102, for example, a personal computer (PC), a tablet terminal apparatus, a smartphone, and other similar devices can be used.

The web server 103 executes processing including creating annotation, uploading data sets, managing supervised learning, providing a social networking service (SNS) function, and the like and functions as a machine learning system portal site.

The storage server 104 stores data sets created for supervised learning. A data set is provided with attribute information of the data set. The contents of a data set is different depending on the inference task, and, for example, a data set for an object detection task includes one or more images and coordinate positions in the image of an object corresponding to the detection target.

The learning server 105 performs supervised learning, creates reports of test results of trained models (inference models) generated by the supervised learning, stores learning parameters for the supervised learning, deploys the inference model, and the like.

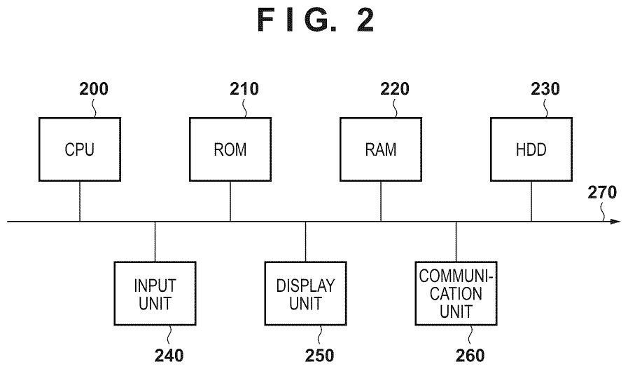

Next, an example of the hardware configuration of a computer apparatus that can be used as the web server 103, the storage server 104, the learning server 105, and the client terminal 102 will be described using the block diagram of FIG. 2. Hereinafter, to simplify description, the web server 103, the storage server 104, the learning server 105, and the client terminal 102 are all described as having the hardware configuration illustrated in FIG. 2, but their hardware configuration is not limited thereto.

A CPU 200 is a central processing unit that executes various types of processing using computer programs and data stored in a random access memory (RAM) 220. Accordingly, the CPU 200 performs overall operation control of the computer apparatus together with executing or controlling the various types of processing described as processing executed by the apparatuses the present computer apparatus is applied to.

Read-only memory (ROM) 210 stores settings data of the computer apparatus, computer programs and data relating to starting up the computer apparatus, computer programs and data relating to basic operations of the computer apparatus, and the like.

The RAM 220 includes an area for storing computer programs and data loaded from the ROM 210 and a HDD 230 and an area for storing computer programs and data received from an external apparatus via a communication unit 260. Also, the RAM 220 includes a working area used by the CPU 200 when executing the various types of processing. The RAM 220 of such a configuration can provide various areas as appropriate.

The HDD 230 stores an operating system (OS), computer programs and data for the CPU 200 to execute or control the various types of processing described as processing executed by the apparatuses the present computer apparatus is applied to, and the like. Note that in addition to or instead of the HDD 230, an external storage apparatus may be used. An external storage apparatus, for example, can be implemented by media (a storage medium) and an external storage drive for implementing access to the media. Known examples of such media include a flexible disk (FD), a CD-ROM, a DVD, USB memory, MO, flash memory, and the like. Also, the external storage apparatus may be a server apparatus or the like connected via a network.

An input unit 240 is a user interface such as a keyboard, a mouse, a touch panel screen that the user operates to input various types of instructions and information into the computer apparatus.

A display unit 250 includes a liquid crystal screen or a touch panel screen and can display the processing results from the CPU 200 using images, characters, and the like. Note that the display unit 250 may be a projection apparatus such as a projector that projects images and characters.

Note that in a case where the present computer apparatus is applied to the web server 103 and the learning server 105, the input unit 240 and the display unit 250 may be omitted. The communication unit 260 communicates data with the external apparatus via the Internet 100 or the local network 101 as described above.

The CPU 200, the ROM 210, the RAM 220, the HDD 230, the input unit 240, the display unit 250, and the communication unit 260 are all connected to a system bus 270. Note that the hardware configuration illustrated in FIG. 2 is merely an example and can be changed or modified as appropriate.

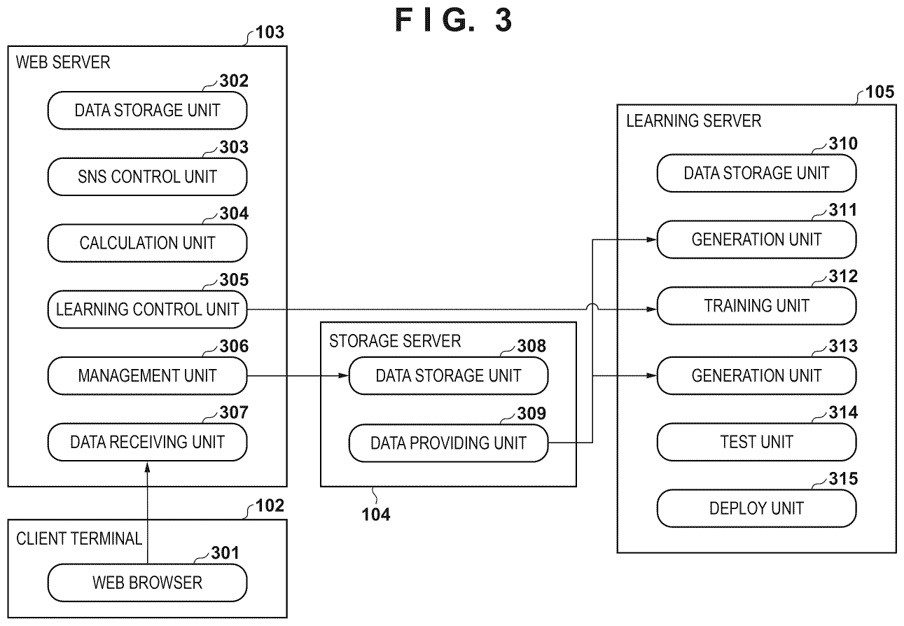

FIG. 3 is a block diagram illustrating an example of the functional configurations of the web server 103, the storage server 104, the learning server 105, and the client terminal 102. In the example described below, of the functional units illustrated in FIG. 3, each functional unit excluding a data storage unit 302, a data storage unit 308, and a data storage unit 310 is implemented via software (a computer program). In this case, the data storage unit 302, the data storage unit 308, and the data storage unit 310 are implemented via a memory apparatus such as the ROM 210, the RAM 220, and the HDD 230. Also, the functional units excluding the data storage unit 302, the data storage unit 308, and the data storage unit 310 may be described below as the subject executing processing. However in practice, the functions the functional units are implemented by the CPU 200 executing the computer program corresponding to the functional unit. Note that for the functional units illustrated in FIG. 3, one or more of the functional units excluding the data storage unit 302, the data storage unit 308, and the data storage unit 310 may be implemented via hardware.

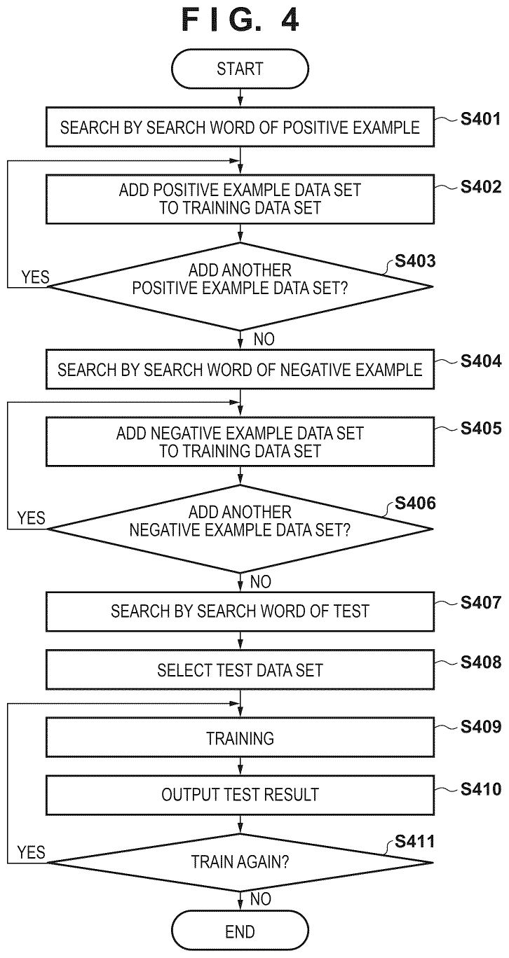

Regarding the system according to the present embodiment, processing executed for training and testing an inference model via supervised learning will be described in accordance with the flowchart of FIG. 4. In the example described below, supervised learning is performed for an object detection task for detecting a black toy poodle from an image.

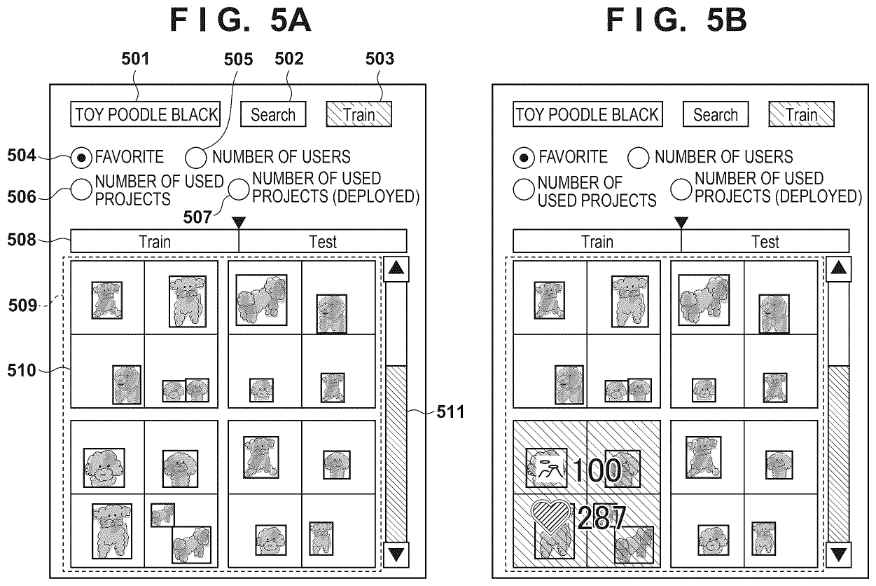

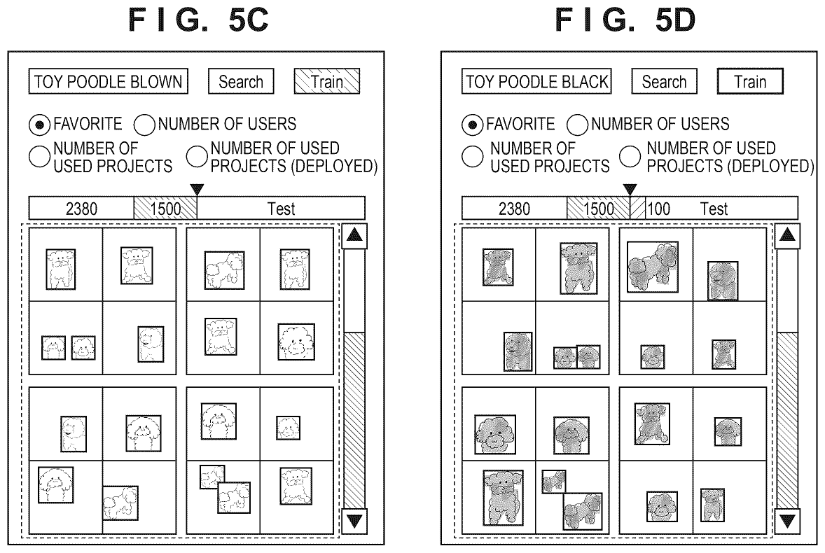

At the start point of the processing according to the flowchart of FIG. 4, a web browser 301 of the client terminal 102 displays a web screen (data set SNS browser screen) illustrated in FIG. 5A on the display screen of the display unit 250. For example, the web browser 301 accesses the web server 103, requests the web screen, receives the web screen transmitted from the web server 103 in response to the request, and displays the web screen on the display unit 250. Hereinafter, unless specifically mentioned, the display control of the web screen and the processing of the web screen with respect to user operations are performed by the web browser 301.

A search window 501 is a text box for entering a query for searching for an object corresponding to the target of the object detection task. The user can operate the input unit 240 of the client terminal 102 to enter a query in the search window 501. In FIG. 5A, the query “toy poodle black” is entered in the search window 501.

A search button 502 is a button for instructing to perform a search. When the user operates the input unit 240 and issues an instruction via the search button 502, the web browser 301 transmits a data set search instruction based on the query entered in the search window 501 to the web server 103. In the present embodiment, since “toy poodle black” is designated as the query, the web browser 301 transmits a data set search instruction provided with a label including “toy poodle black” to the web server 103.

The, when the web browser 301 receives a data set group, which is the search result in accordance with the search instruction, from the web server 103, for each data set of the data set group, thumbnails 510 representing the data set are generated and displayed in a region 509. The data set received from the web server 103 includes images including a black toy poodle and coordinate positions of a “black toy poodle” in the image. The web browser 301 generates the thumbnails 510 with “images including a black toy poodle” included in the data set arranged. At this time, the web browser 301 superimposes a “bounding box as a GT for object detection” at the “toy poodle black” coordinate positions in the “images including a black toy poodle”.

A train button 503 is a button for instructing to perform supervised learning, and this is enables when one or more data set used in training (training data set) and one or more data set used for testing (test data set) are selected. When the user operates the input unit 240 and issues an instruction via the train button 503, the web browser 301 transmits a train instruction including training data set identification information and test data set identification information to the web server 103. The training data set identification information includes information for identifying each data set added to the training data set. The test data set identification information includes information for identifying the test data set.

A radio button 504 is a radio button for designating “number of favorites registered by user” as a condition for regulating the sort order of the data set displayed in the region 509. The data set with the most number of registered favorites is the data set favored by the majority of users performing training. Thus, the data set likely has high annotation quality, and by preferentially searching or using such a data set, the inference model accuracy is likely to improve. When the user operates the input unit 240 and issues an instruction via the radio button 504, the web browser 301 displays each generated thumbnail 510 in order sorted by “number of favorites registered by users” in the region 509.

A radio button 505 is a radio button for designating “number of users using data set” as a condition for regulating the sort order of the data set displayed in the region 509. When the user operates the input unit 240 and issues an instruction via the radio button 505, the web browser 301 displays each generated thumbnail 510 in order sorted by “number of users using data set” in the region 509.

A radio button 506 is a radio button for designating “used project number” as a condition for regulating the sort order of the data set displayed in the region 509. When the user operates the input unit 240 and issues an instruction via the radio button 506, the web browser 301 displays each generated thumbnail 510 in order sorted by “number of projects using data set corresponding to the thumbnail 510” in the region 509.

A radio button 507 is a radio button for designating “deployed project number” as a condition for regulating the sort order of the data set displayed in the region 509. When the user operates the input unit 240 and issues an instruction via the radio button 507, the web browser 301 displays each generated thumbnail 510 in order sorted by “number of projects deployed from among projects using data set corresponding to the thumbnail 510” in the region 509.

In this manner, the annotation quality can be indirectly estimated from the popularity of the data set using the radio buttons 504 to 507. Note that the radio buttons 504 to 507 are controlled by the web browser 301 so that only one is selectable at a time. Also, the sort conditions of the thumbnails 510 are not limited to the conditions described above, and the sort condition designating method is also not limited to the method described above. Annotation that improves at least one of accuracy (how correct inferences are) of the trained learning model, recall (of corrects that are positive examples, how many positive examples were inferred), and precision (of those inferred to be positive examples, how many were correct) can be considered high quality. Examples include annotation (tag) that appropriately represents an object, annotation that appropriately encloses an object region, correct annotation for objects difficult to tell apart (for example, long-haired Norwegian forest cats and Maine Coons), and the like. However, it is not easy to discern whether annotation is high quality and gather annotations with high quality. Regarding this, using an evaluation index described below, annotation considered to be high quality (teacher data considered to be high quality) can be obtained and training can be performed.

An indicator 508 indicates how many data sets selected in response to a user operation from the region 509 are selected for training and testing. The indicator 508 represents the ratio of positive examples and negative examples in the training data set, the ratio of test data sets to training data sets, and the like using a different color for each.

A scrollbar 511 is for scrolling through the contents of the region 509 and is used to visually represent the number of data set search hits using the thickness of the scrollbar 511.

In step S401, when the user operates the input unit 240 and issues an instruction via the search button 502, the web browser 301 transmits a search instruction of a data set (positive example data set) provided with a label including “toy poodle black” of the query entered in the search window 501 as the search word of a positive example data set to the web server 103. Then, the web browser 301 receives a positive example data set group, which is the search result in accordance with the transmitted search instruction, from the web server 103. Then, the web browser 301 generates the thumbnails 510 corresponding to the positive example data sets in the received positive example data set group and displays the thumbnails 510 in the region 509.

In step S402, the web browser 301 adds to the training data set a positive example data set corresponding to the thumbnail 510 selected from the thumbnail 510 group displayed in the region 509 by the user by operating the input unit 240.

Here, in a state in which the radio button 504 is selected, if the user operates a mouse as the input unit 240 and puts the mouse cursor over the thumbnail 510, as illustrated in FIG. 5B, the web browser 301 displays the number of images included in the data set corresponding to the thumbnail 510 and the number of registered favorites for the data set.

Also, in a state in which the radio button 505 is selected, if the user operates a mouse as the input unit 240 and puts the mouse cursor over the thumbnail 510, the web browser 301 displays the number of images included in the data set corresponding to the thumbnail 510 and the number of users using data set.

Also, in a state in which the radio button 506 is selected, if the user operates a mouse as the input unit 240 and puts the mouse cursor over the thumbnail 510, the web browser 301 displays the number of images included in the data set corresponding to the thumbnail 510 and the used project number.

Also, in a state in which the radio button 507 is selected, if the user operates a mouse as the input unit 240 and puts the mouse cursor over the thumbnail 510, the web browser 301 displays the number of images included in the data set corresponding to the thumbnail 510 and the deployed project number.

In the present embodiment, the data set attribute information includes the number of images included in the data set and various evaluation index values for the data set (in the example of FIG. 5B, number of registered favorites, user number, used project number, and project number). Also, if the user operates a mouse as the input unit 240 and puts the mouse cursor over the thumbnail 510, the web browser 301 displays the “number of images included in the data set” included in the attribute information of the data set corresponding to the thumbnail 510 and “various user-set evaluation index values for the data set (an evaluation index value corresponding to the selected radio button from among number of registered favorites, user number, used project number, and project number). Thus, the user can look into the data set to be added to the training data set by referencing such a display.

Note that the operation of putting the mouse cursor over the thumbnail 510 is merely an example of an operation for selecting attribute information of a data set corresponding to the thumbnail 510 for user reference, and another user operation may be used to display the attribute information of the data set. Also, the attribute information of the data set may always be displayed. Also, the method for displaying the attribute information of the data set is not limited to a specific display method.

In step S403, the web browser 301 determines whether or not the user has operated the input unit 240 and input an instruction to end the processing to add a positive example data set to the training data set.

As the result of this determination, in a case where the user has operated the input unit 240 and input an instruction to end the processing to add a positive example data set to the training data set, the processing proceeds to step S404. On the other hand, in a case where the user has not operated the input unit 240 and input an instruction to end the processing to add a positive example data set to the training data set, the processing proceeds to step S402.

The user operates the input unit 240 and enters a query into the search window 501 to search for a data set (negative example data set) for performing negative training so that objects to be excluded from the detection target and objects that tend to be falsely detected are not detected. In the present embodiment, to performing training of brown toy poodles as a negative example, the user operates the input unit 240 and enters “toy poodle brown” in the search window 501 as a query to search for a negative example data set.

In step S404, when the user operates the input unit 240 and issues an instruction via the search button 502, the web browser 301 transmits a search instruction of a data set (negative example data set) provided with a label including “toy poodle brown” of the query entered in the search window 501 as the search word of a negative example data set to the web server 103. Then, the web browser 301 receives a negative example data set group, which is the search result in accordance with the transmitted search instruction, from the web server 103. Then, the web browser 301 generates the thumbnails (negative example thumbnails) corresponding to the negative example data sets in the received negative example data set group and displays the thumbnails 510 in the region 509.

In step S405, the web browser 301 adds to the training data set a negative example data set corresponding to the negative example thumbnail selected from the negative example thumbnail group displayed in the region 509 by the user by operating the input unit 240.

FIG. 5C illustrates an example display of the web screen after the processing of step S405 is complete. As illustrated in FIG. 5C, in the web screen of FIG. 5A, in a region with “Train” displayed in the indicator 508, the number (left side number) of images included in the positive example data set added to the training data set and the number (right side number) of images included in the negative example data set added to the training data set are displayed in different display colors. Also, the ratio of the horizontal width of the display region of the “number of images included in the positive example data set added to the training data set” and the horizontal width of the display region of the “number of images included in the negative example data set added to the training data set” corresponds to the ratio of the “number of images included in the positive example data set added to the training data set; and the “number of images included in the negative example data set added to the training data set”, for example.

In step S406, the web browser 301 determines whether or not the user has operated the input unit 240 and input an instruction to end the processing to add a negative example data set to the training data set.

As the result of this determination, in a case where the user has operated the input unit 240 and input an instruction to end the processing to add a negative example data set to the training data set, the processing proceeds to step S407. On the other hand, in a case where the user has not operated the input unit 240 and input an instruction to end the processing to add a negative example data set to the training data set, the processing proceeds to step S405.

In step S407, when the user operates the input unit 240 and issues an instruction via the search button 502, the web browser 301 transmits a search instruction of a data set (test data set) provided with a label including “toy poodle black” of the query entered in the search window 501 as the search word of a test example data set to the web server 103. Then, the web browser 301 receives a test data set group, which is the search result in accordance with the transmitted search instruction, from the web server 103. Then, the web browser 301 generates the thumbnails (test thumbnails) corresponding to the test data sets in the received test data set group and displays the thumbnails 510 in the region 509.

In step S408, the web browser 301 obtains, as the selected test data set, the test data set corresponding to the test thumbnail selected from the test thumbnail group displayed in the region 509 by the user operating the input unit 240.

FIG. 5D illustrates an example display of the web screen after the processing of step S408 is complete. As illustrated in FIG. 5D, in the web screen of FIG. 5A, in the indicator 508 in the region where “Test” is displayed, a region with a horizontal width corresponding to the number of images included in the selected test data set is displayed in color together with the number (100). The ratio of the horizontal width of the display region of the “number of images included in the positive example data set/negative example data set added to the training data set” and the horizontal width of the display region of the “number of images included in the selected test data set” corresponds to the ratio of the “number of images included in the positive example data set/negative example data set added to the training data set” and the “number of images included in the selected test data set”, for example.

Also, when adding data sets to the training data set and obtaining the selected test data sets are complete, as illustrated in FIG. 5D, the train button 503 that was disabled (in a state in which it cannot be selected by the user using the input unit 240) in FIG. 5A is enabled (in a state in which it can be selected by the user using the input unit 240).

In step S409, when the user operates the input unit 240 and issues an instruction via the train button 503, the web browser 301 transmits a train instruction including training data set identification information and test data set identification information to the web server 103.

Here, the operations and configuration examples of the web server 103, the storage server 104, and the learning server 105 will be described. First the web server 103 will be described. The data storage unit 302 stores (holds) data managed on the web server 103. The data held in the data storage unit 302, for example, include registration information such as a user name and password of users that use the present system and SNS related information such as follows and followers.

An SNS control unit 303 provides SNS functions such as follows and direct messages between users, registration of favorite data sets, and the like and, in response to user interaction, manipulates the data stored in the data storage unit 302. A calculation unit 304, on the basis of various calculation methods, converts the popularity or quality of data sets into numerical values as index values for making a desired data set easy to find.

A learning control unit 305 handles management and control of the supervised learning for achieving a desired task and transmits, to the learning server 105, a learning job, which is a job for causing the learning server 105 to perform training or a test based on the train instruction transmitted from the web browser 301. The learning job includes identification information of the training data set used in training and identification information of the test data set used in a test.

A management unit 306 manages the data sets by uploading “data sets for uploading” transmitted from the client terminal 102 to the storage server 104, deleting data sets already uploaded to the storage server 104, and the like.

A data receiving unit 307 receives various types of information transmitted from the web browser 301 (for example, user interactions and data to be uploaded to the storage server 104).

Next, the storage server 104 will be described. The data storage unit 308 stores (holds) the data sets uploaded by the management unit 306. A data providing unit 309 transmits, of the data sets stored in the data storage unit 308, a data set corresponding to the “identification information of the training data set” included in the learning job received from the learning control unit 305 as the training data set to the learning server 105. Also, the data providing unit 309 transmits, of the data sets stored in the data storage unit 308, a data set corresponding to the “identification information of the test data set” included in the learning job received from the learning control unit 305 as the test data set to the learning server 105.

When the management unit 306 receives a search instruction for a data set (positive example data set/negative example data set/test data set) from the web browser 301 via the data receiving unit 307, the management unit 306 performs a search in accordance with the search instruction of the data sets stored in the data storage unit 308. Then, the data receiving unit 307 transmits the search result to the web browser 301.

In this manner, various data sets uploaded from the client terminal 102 of users can be registered in the data storage unit 308, and a positive example data set/negative example data set/test data set can be selected from the registered data set group. In other words, in the system according to the present embodiment, data sets are shared between users, and a positive example data set/negative example data set/test data set can be selected from such data sets.

Next, the learning server 105 will be described. The data storage unit 310 stores, for each project, a definition file of information for specifying an inference model, a data set used in the learning project progress management and training and testing, hyperparameters set for learning, inference models, and the like. In other words, the learning server 105 stores a training data set used in training and a test data set used in testing in the data storage unit 310 each time a learning job is received.

A generation unit 311 performs appearance frequency adjustment for each data set received from the data providing unit 309 and preprocessing for inputting into the inference model, and the like. A generation unit 313 performs preprocessing for inputting into the inference model but does not perform appearance frequency adjustment for each data set received from the data providing unit 309.

A training unit 312 trains an inference model (a selected model selected as a model suitable for a task) using a training data set transmitted from the data providing unit 309 on the basis of the learning job from the learning control unit 305.

A test unit 314, for each of the test data sets transmitted from the data providing unit 309, inputs the test data set into the inference model and executes inference model computational processing (inference processing), obtains “performance information indicating the performance of the inference model obtained for the present project” including recall and precision on the basis of the specified test conditions, and notifies the user of the performance information. For example, the test unit 314 may display the performance information on the display unit 250 of the learning server 105 using images or characters and may transmit the performance information to the web browser 301 for display on the web browser 301. A deploy unit 315 puts a “completed inference model” generated via the training or testing described above in a real operation state so that it can be used in response to a HTTP request.

Thus, in step S409, after the web browser 301 transmits the train instruction to the web server 103, inference model learning processing is executed via the operations of the web server 103, the storage server 104, and the learning server 105 as described above.

Also, in step S410, performance information of each test data set is obtained by executing the processing described above using the test unit 314. Then, for example, the test unit 314 generates notification information such as performance information indicating the highest performance amongst the performance information (highest performance information), a data set corresponding to the highest performance information, and the like and transmits the notification information to the web browser 301. The web browser 301 displays the notification information using images and characters. Note that the information included in the notification information is not limited to that of the example described above.

In step S411, the web browser 301 determines whether or not the train button 503 has been used again to issue an instruction. For example, the user looks at the screen of the web browser 301 based on the notification information and determines whether or not training needs to be performed again. In a case where it is determined that training needs to be performed again, the train button 503 is used to issue an instruction.

In a case where the train button 503 is used to issue an instruction again, the processing proceeds to step S409. In a case where the train button 503 is not used to issue an instruction, the processing according to the flowchart of FIG. 4 ends.

### First Modified Example

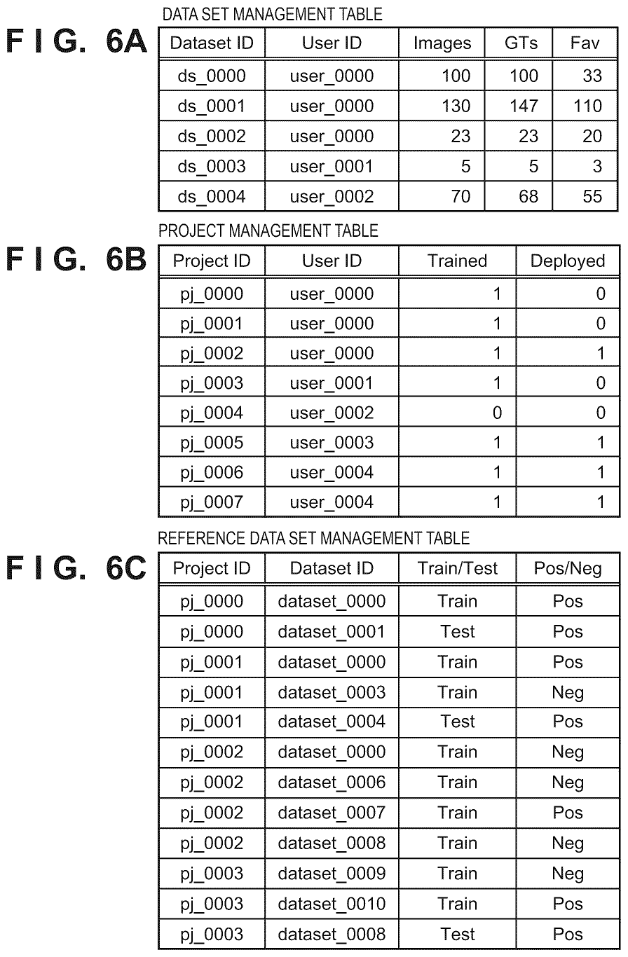

The operations of the system in a case where the radio button 506 is used to issue an instruction will now be described using the example tables illustrated in FIGS. 6A to 6C. The tables of FIGS. 6A to 6C are held/managed by the storage server 104.

FIG. 6A illustrates an example of a data set management table for managing the data sets uploaded to the storage server 104. When a data set is uploaded, the storage server 104 issues the data set with a unique Dataset ID. Then, the storage server 104 associates together the Dataset ID issued for the data set, the User ID (identification information) unique to the creator of the data set, the number of images included in the data set (Images), the number of GTs in the images, and the number of registered favorites for the data set (Fav) and registers these in the data set management table.

FIG. 6B illustrates an example of a project management table. The storage server 104 issues a unique Project ID for each learning project of the users. Then, the storage server 104 associates together the Project ID issued for the project, the User ID unique to the creator of the project, the trained status of the inference model corresponding to the project (Trained), and the deployed status of the inference model (Deployed) and registers these in the project management table. Being untrained is indicated by Trained equaling 0, and being trained is indicated by Trained equaling 1. Also, being undeployed is indicated by Deployed equaling 0, and being deployed is indicated by Deployed equaling 1.

FIG. 6C illustrates an example of a reference data set management table. The reference data set management table is a table in which the data sets used in training and testing are managed per project. In FIG. 6C, for visibility, the management tables of the projects are joined together as a table.

The Train/Test column indicates whether the data set is used in training or in testing. “Train” indicates that the data set is used in training, and “Test” indicates that the data set is used in testing.

The Pos/Neg column indicates whether the data set is a positive example data set or a negative example data set. “Pos” indicates that the data set is a positive example data set, and “Neg” indicates that the data set is a negative example data set.

The number of projects using the data set can be counted per Dataset ID by filtering the reference data set management table by Dataset ID. For example, in the example of FIG. 6C, dataset_0000 corresponds to three Project IDs (pi_0000, pi_0001, and pi_0002). Thus, the number of projects using the data set “dataset 0000” is three. The data set used project number is retrieved by the following SQL statement.
SELECT DatasetID, COUNT (*)
   FROM reference data set management table
   GROUP BY DatasetID

In the case of obtaining the popularity of the data set in the training phase, the results of filtering by Dataset ID and Train and Pos is counted. The number is retrieved as follows by the SQL statement.
SELECT DatasetID, COUNT (*)
FROM reference data set management table
WHERE Train/Test=Train AND Pos/Neg=Pos
GROUP BY DatasetID

In a case where the radio button 507 for sorting by the number of used projects in which the data set search result is deployed is checked, filtering is further applied using the Deployed column of the project management table. In this manner, the projects can be restricted down to learning projects used in actual real environments, so that the usefulness of the data set at the top of the search is strongly suggested. Also, in a case where the present model is applied to an edge device, the number of times installed on an edge device may be used instead of the number of times deployed.

In this manner, by the user searching for a data set they wish to use and displaying search results that take into consideration popularity, an effective and efficient data set selection at a stage before training is supported, allowing for training for obtaining an inference model matching their purpose to be effectively performed.

Note that in the first embodiment, a search in accordance with the search instruction is performed of the data sets stored in the data storage unit 308. However, for example, in a case where a positive example data set is selected, a search in accordance with the search instruction may be performed of the data sets corresponding to “Pos” in the Pos/Neg column and the data sets corresponding to “Train” in the Train/Test column. A similar approach is used also in the case of searching negative example data sets. Also, in the case of selecting a test data set, a search in accordance with the search instruction may be performed of the data sets corresponding to “Test” in the Train/Test column.

### Second Embodiment

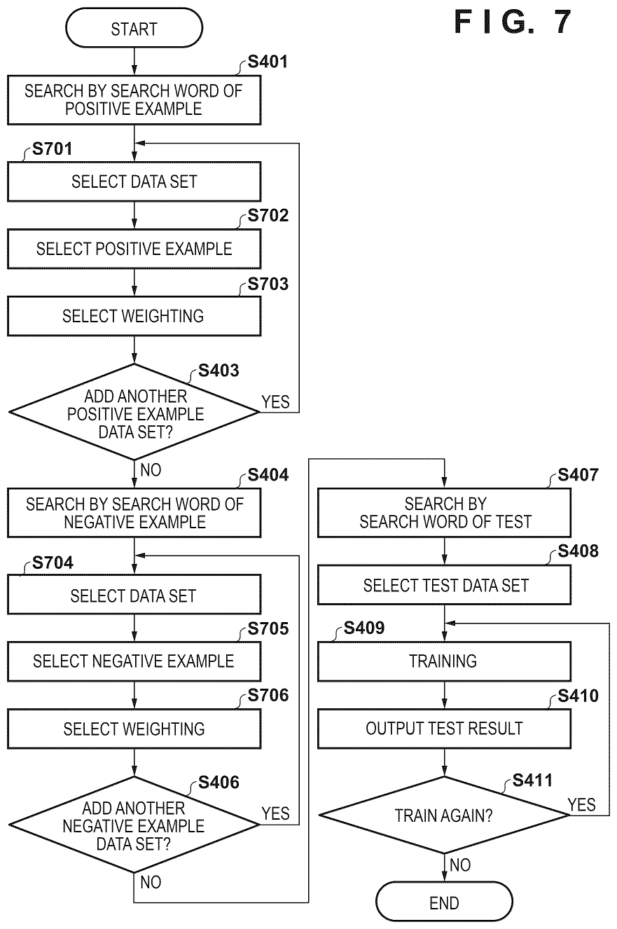

In the embodiments described below, including the present embodiment, the differences between the first embodiment will be described, and unless particularly mentioned, the hardware configuration and the like are the same as in the first embodiment. Regarding the system according to the present embodiment, processing executed for training and testing an inference model via supervised learning will be described in accordance with the flowchart of FIG. 7. In the flowchart of FIG. 7, processing steps that are similar to the processing steps illustrated in FIG. 4 are given the same step number and description thereof is omitted.

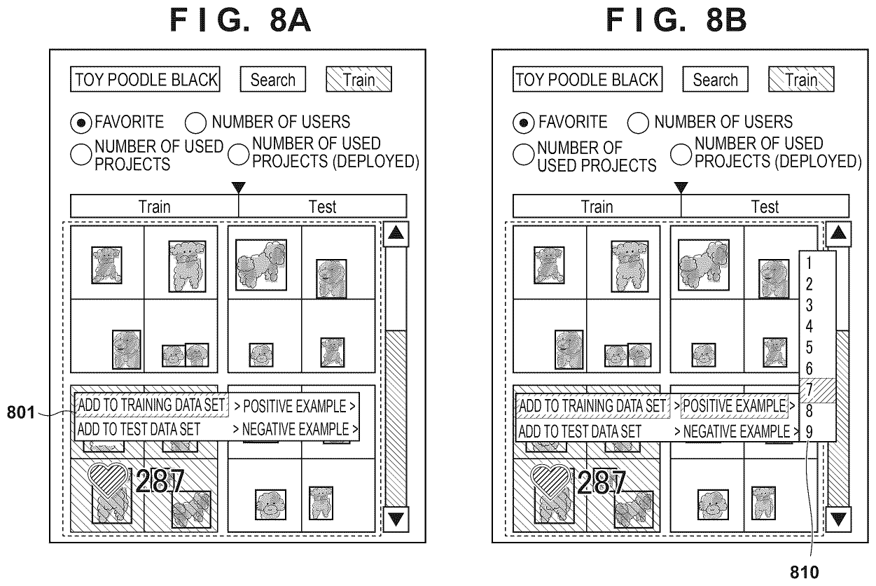

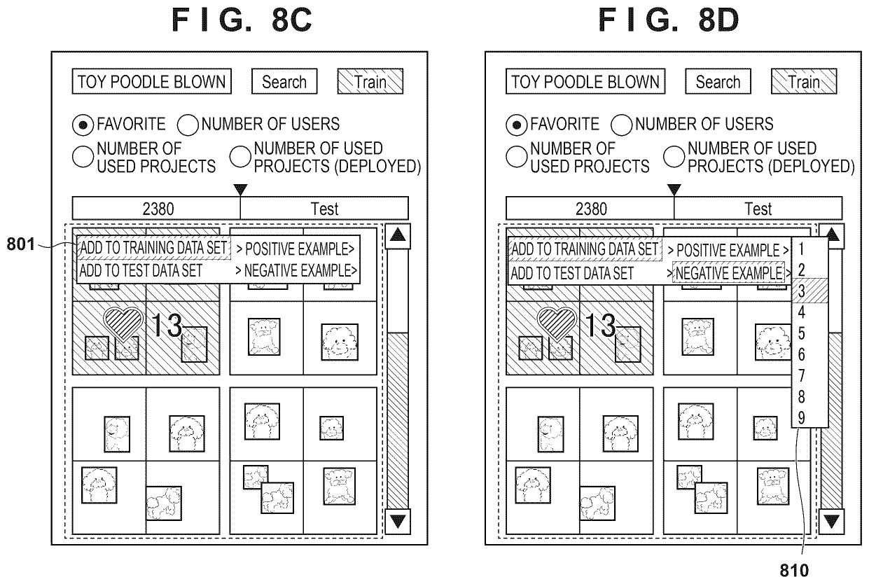

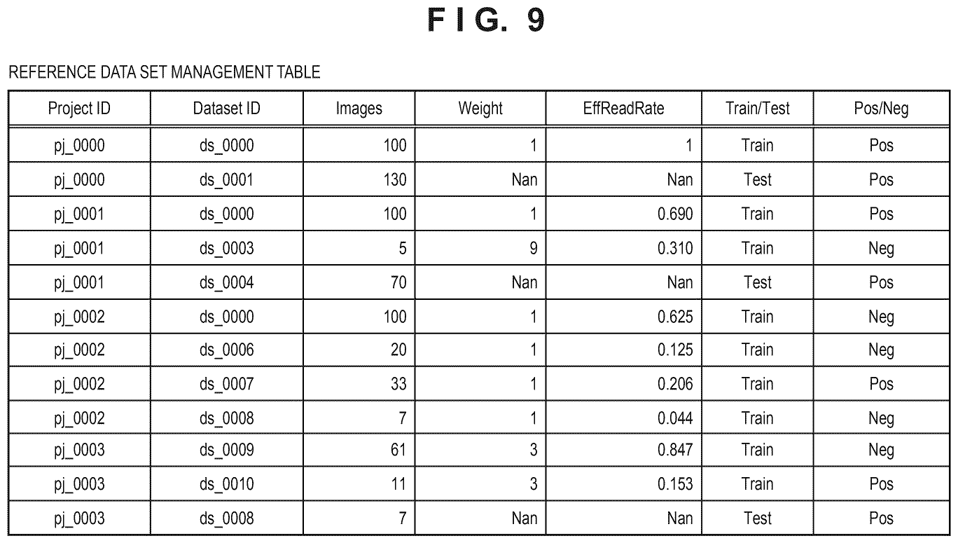

At the start point of the processing according to the flowchart of FIG. 7, the web browser 301 of the client terminal 102 displays a web screen (data set SNS browser screen) illustrated in FIG. 8A on the display unit 250. For example, the web browser 301 accesses the web server 103, requests the web screen, receives the web screen received from the web server 103 in response to the request, and displays the web screen on the display unit 250.

In step S701, the web browser 301 displays a menu relating to the selected data set selected from a data set group displayed in the region 509 by the user operating the input unit 240. For example, when the user operates the mouse as the input unit 240 and puts the mouse cursor over a data set (selected data set), as illustrated in FIG. 8A, the web browser 301 displays a menu 801 for selecting whether to add the selected data set to the training data set as a positive example data set or whether to add the selected data set to the training data set as a negative example data set.

In step S702, if the user operates the mouse as the input unit 240 and selects “add to training data set” and “positive example” in the menu 801, the web browser 301 adds the selected data set to the training data set as a positive example data set. On the other hand, if the user operates the mouse as the input unit 240 and selects “add to training data set” and “negative example”, the web browser 301 adds the selected data set to the training data set as a negative example data set.

In step S703, if a state in which “add to training data set” and “positive example” are selected in the menu 801 continues for a specified amount of time or more in step S702, the web browser 301 displays the menu 810 for selecting weighting as illustrated in FIG. 8B. Here, weighting is for adjusting the probability of appearance between training data sets. Higher values mean that it will appear in the training data set with a higher probability, allowing for the contribution to training to be controlled per data set. The user can select the desired weighting (weighting of a positive example data set in step S703) from the menu 810 by operating the input unit 240.

In step S704, as illustrated in FIG. 8C, the web browser 301 displays the menu 801 relating to the selected data set selected from a data set group displayed in the region 509 by the user operating the input unit 240.

In step S705, if the user operates the mouse as the input unit 240 and selects “add to training data set” and “negative example” in the menu 801, the web browser 301 adds the selected data set to the training data set as a negative example data set.

In step S706, if a state in which “add to training data set” and “negative example” are selected in the menu 810 continues for a specified amount of time or more in step S705, the web browser 301 displays the menu 801 for selecting weighting as illustrated in FIG. 8D. The user can select the desired weighting (weighting of a negative example data set in step S706) from the menu 810 by operating the input unit 240.

Also, in the present embodiment, in step S409, when the user operates the input unit 240 and issues an instruction via the train button 503, the web browser 301 transmits a train instruction including training data set identification information, test data set identification information, and data set weighting to the web server 103. The web server 103 transmits “data set weighting” included in the train instruction received from the web browser 301 to the storage server 104.

The storage server 104 first calculates the data set effective read rate of each project in advance and registers this. The effective read rate of data set ds_j used in project pj_i can be calculated according to Formula (1) below.

### (Effective Read Rate)

(weighting for ds_j)×(number of images in ds_j)/93 _{ds_k∈Dataset}{(weighting for ds_k)×(number of images in ds_k)} (1)

The denominator is a normalization member, and the target of the sum represented by ds_k∈Dataset corresponds to the entire data set used in training by project pj_i. For example, in the reference data set management table of FIG. 9, the effective read rate of data set ds_0000 of project pj_0001 is calculated as 1×100/(1×100+9×5)≈0.69. In the EffReadRate column of FIG. 9, the calculated effective read rate is registered for each data set of each project. Regarding data sets used in tests, the effective read rate is not calculated. This is represented by Nan. In this manner, in the FIG. 9, the collective weighted average of the positive example data sets and the negative example data sets used in training is found, and the effective read rate is calculated. However, the effective read rate may be calculated for only the positive example data sets to further narrow the data sets down to the task training data sets for the purpose. The reference data set management table of FIG. 9 is held/managed by the storage server 104.

The storage server 104 calculates the result of summing the effective read rates calculated for each data set of each project across all of the projects using the data set as training to obtain an evaluation index value of the data set. For example, the calculation unit 304 obtains the evaluation index value of a data set according to Formula (2) below.

### (Data Set Evaluation Index Value)

Σ_{pj_i∈Project}(effective read rate of data set for pj_i) (2)

Then, the storage server 104 may update the evaluation index value included in the attribute information of the data set with the evaluation index value obtained for the data set. In this case, thumbnails for the data set stored on the basis of the evaluation index value can be displayed in the region 509.

Also, the evaluation index value for the data set can be considered an expected value of the images included in the data set being used in training during one iteration when each project is trained equally. The learning server 105 performs supervised learning so that the images included in the data sets are used in the supervised learning with data sets of a high evaluation index value being used at a higher probability. Accordingly, an effective and efficient data set selection at a stage before training is supported, allowing for training for obtaining an inference model matching their purpose to be effectively performed.

### Third Embodiment

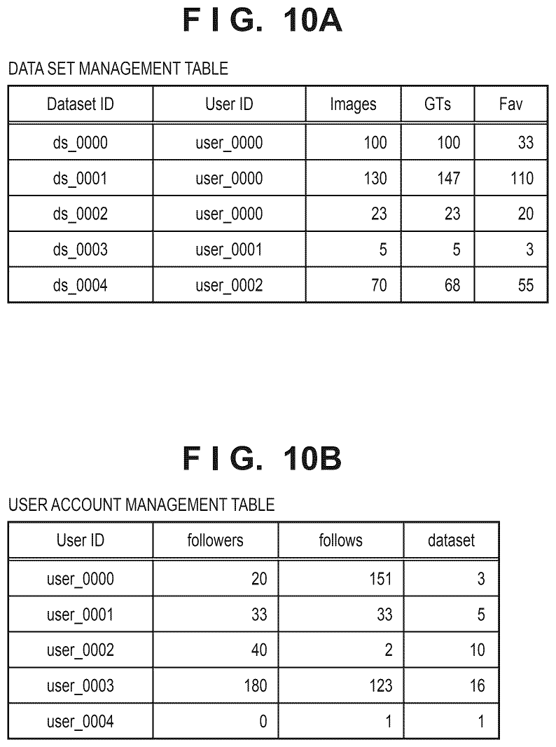

In the present embodiment, the storage server 104 obtains the evaluation index value of the data set on the basis of the attributes associated with the identification information of the user associated with the data set. In the present embodiment, the table examples of FIGS. 10A and 10B will be described. The tables of FIGS. 10A and 10B are held/managed by the storage server 104.

The data set management table of FIG. 10A is similar to the data set management table of FIG. 6A. In the user account management table of FIG. 10B, followers represents the number of accounts following the user, and follows represents the number of accounts the user is following. Also, dataset represents the number of data sets uploaded to the storage server 104 by the user. In such a case, the storage server 104 obtains the evaluation index value of the data set on the basis of Formula (3) below.

### (Data Set Evaluation Index Value)

(User follower number)×(user total number of assigned GTs)/(scaling member) x (data set GT number) (3)

For example, in the case of obtaining the evaluation index value of the data set with a Dataset Id of ds_0000, the follows of user_0000 corresponding to ds_0000 corresponds to a “user follower number” of “20” from the “20” in the user account management table. Also, the GTs corresponding to user_0000 corresponding to ds_0000 are “100”, “147”, and “23” from the data set management table. Thus, the storage server 104 calculates 100+147+23 with a scaling member of “1” and obtains a calculation result (total number) of “270” as the “user total number of assigned GTs”. Also, the data set GT number, which is the number of GTs corresponding to ds_0000 is “100”. Thus, the storage server 104 calculates, via Formula (3) above, 20×270×100 and obtains a result of “540000” as the “evaluation index value”. Note that the scaling member can be used for scaling via any monotonically increasing function in conjunction with scaling up the service.

Users with a large number of followers and high GT assigning performance are considered highly experienced annotators. Data sets with a large number of GTs assigned by such a user have a high evaluation index value.

Then, the storage server 104 may update the evaluation index value included in the attribute information of the data set with the evaluation index value obtained for the data set. In this case, thumbnails for the data set stored on the basis of the evaluation index value can be displayed in the region 509.

Also, the learning server 105 performs supervised learning so that the images included in the data sets are used in the supervised learning with data sets of a high evaluation index value being used at a higher probability. Accordingly, training can be performed by selectively using data sets including a large number of high quality GTs from a highly experienced annotator. This increases the possibility of obtaining a highly accurate inference model.

Note that in the present embodiment, the evaluation index value is calculated on the premise that the data set creator user and the annotator are the same. However, by associating a user to each GT, weighting for annotators can be applied to each GT. Even in the case of a data set made by a plurality of annotators, in a similar manner, the index can be an index for measuring the annotation quality of data sets.

Also, in the system of FIG. 1 used in the embodiments described above, three server apparatuses, the web server 103, the storage server 104, and learning server 105 are used. However, the functions of two or more of these server apparatuses may be implemented as a single server apparatus. Also, at least one of the web server 103, the storage server 104, and the learning server 105 may be implemented by dividing the functions into two or more server apparatuses.

Also, in the embodiments described above, the data set includes one or more images and the coordinate positions in the image of the detection target object. However, the configuration of the data set is not limited to this configuration, and a data set including an image and the position of a GT in the image may be used. Also, as a data set, a data set including data other than images (for example audio data) and the position of a GT in the image (for example, the position/section of the GT in the audio data) may be used. In such a case, the attribute information of the data set includes the number of pieces of data included in the data set and the evaluation index value representing user evaluation of the data set.

The numerical values; processing timing; processing order; processing; subjects of processing; obtaining method, transmission destination, transmission source, and storage place of data (information); and the like used in the embodiments and modified examples described above are examples for facilitating a detailed description, and no such limitations are intended.

Also, a part or all of the embodiments and modified examples described above may be combined as appropriate. Furthermore, a part or all of the embodiments and modified examples described above may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-006207, filed Jan. 18, 2024, which is hereby incorporated by reference herein in its entirety.

What is claimed is:

1. An information processing apparatus comprising:
an obtaining unit configured to obtain a data set shared by users; and
an instructing unit configured to issue an instruction for supervised learning based on the data set obtained by the obtaining unit, wherein attribute information of the data set includes a number of pieces of data included in the data set and an evaluation index value representing a user evaluation for the data set.

2. The information processing apparatus according to claim 1, wherein the obtaining unit obtains a positive example data set found via search of a data set group shared by users as a data set of positive examples and obtains a negative example data set found via search of the data set group as a data set of negative examples.

3. The information processing apparatus according to claim 2, wherein the instructing unit
displays the positive example data set on a display screen and adds a first data set selected from the positive example data set according to a user operation to a training data set,
displays the negative example data set on the display screen and adds a second data set selected from the negative example data set according to a user operation to the training data set, and
issues an instruction to perform supervised learning based on the training data set.

4. The information processing apparatus according to claim 3, wherein the instructing unit displays attribute information of a data set on the display screen in response to a user operation on the data set displayed on the display screen.

5. The information processing apparatus according to claim 1, wherein the data set includes an image and a GT in the image.

6. A system comprising:
an information processing apparatus including
an obtaining unit configured to obtain a data set shared by users, and
an instructing unit configured to issue an instruction for supervised learning based on the data set obtained by the obtaining unit, wherein attribute information of the data set includes a number of pieces of data included in the data set and an evaluation index value representing a user evaluation for the data set; and
a server apparatus, wherein
the server apparatus includes
a first processing unit configured to obtain a read rate of a data set on a basis of a number of pieces of data included in the data set used in a project and a weighting input according to a user operation in the information processing apparatus for the data set,
a second processing unit configured to obtain an evaluation index value representing a user evaluation of a data set on a basis of a sum of read rates obtained for each project for the data set, and
a third processing unit configured to perform supervised learning on a basis of an instruction from the instructing unit and the evaluation index value.

7. A system comprising:
an information processing apparatus including
an obtaining unit configured to obtain a data set shared by users, and
an instructing unit configured to issue an instruction for supervised learning based on the data set obtained by the obtaining unit, wherein attribute information of the data set includes a number of pieces of data included in the data set and an evaluation index value representing a user evaluation for the data set; and
a server apparatus, wherein
the server apparatus includes
a first processing unit configured to obtain an evaluation index value representing a user evaluation of a data set on a basis of an attribute associated with identification information of a user associated with the data set, and
a second processing unit configured to perform supervised learning on a basis of an instruction from the instructing unit and the evaluation index value.

8. The system according to claim 7, wherein
the first processing unit obtains the evaluation index value on a basis of a number of GTs included in the data set, a total number of GTs included in each data set associated with the identification information, and a number of accounts following the user.

9. An information processing method executed by an information processing apparatus, comprising:
obtaining a data set shared by users; and
issuing an instruction for supervised learning based on the obtained data set, wherein
attribute information of the data set includes a number of pieces of data included in the data set and an evaluation index value representing a user evaluation for the data set.

10. A non-transitory computer-readable storage medium configured to cause a computer to function as:
an obtaining unit configured to obtain a data set shared by users; and
an instructing unit configured to issue an instruction for supervised learning based on the data set obtained by the obtaining unit, wherein attribute information of the data set includes a number of pieces of data included in the data set and an evaluation index value representing a user evaluation for the data set.
